(19) United States
(12) Patent Application Publication
(10) Pub. No.: US 2022/0212557 A1
(43) Pub. Date: Jul. 7, 2022

(54) Charging system for electric vehicles

(71) Applicant: Ali Hamzeh Chalhoub, Garden City, MI (US)

(72) Inventor: Ali Hamzeh Chalhoub, Garden City, MI (US)

(21) Appl. No.: 16/974,361

(22) Filed: Apr. 21, 2020

(51) Int. Cl. B60L 53/52; H02K 7/18

(52) U.S. Cl. CPC B60L 53/52; H02K 7/183

(57) ABSTRACT

Disclosed is air turbine charging system for electrically powered vehicle. The electrically powered vehicle includes air intake vents and air intake ducts that direct air inside the system with a specific force. The system further includes one or more air turbines coupled with one or more gears and one or more alternators. The air intake vents and air intake ducts direct air to cause rotation of an air turbine causing them and their coupled gears and alternators to rotate and cause an electric current. This electric current is used to charge the battery of the vehicle using a regulator that regulates power between alternator and battery. The amount of air intake from the air intake vents is varied automatically while the vehicle is on move based on predefined conditions. Moreover, there are two batteries associated with the system which are charged and are used alternatively for functioning of the vehicle.

### FIELD OF THE INVENTION

This invention relates generally to electrically powered vehicles and more particularly to a system for charging batteries of the electrically powered vehicles utilizing a wind/air operated turbine.

### BACKGROUND TO THE INVENTION

With an increase in environmental pollution, noise, scarcity of fuel and high fuel prices electrically powered vehicles are becoming increasingly popular. Although electrically powered vehicles may solve some of the mentioned problems, but such vehicles are not yet widespread used due to various limitations related to its battery and power.

The significant limitations associated with battery includes limited travel distance covered by the electrically powered vehicles with a fully charged battery, fear of battery drain while the vehicle is running or operative, finding a charging point and/or charging station, excessive time required for recharging the batteries, and the like. Currently, the average travel distance between electrically powered vehicles is way less than fuel powered vehicles and additionally it may take several minutes to several hours to recharge the battery and moreover on a standby/non-operative mode. For example, an electrically powered car needs between 30 minutes to 8 hours stop to recharge the battery for a distance covered between 50 miles to 300 miles. Also, during the recharge the vehicle remains inoperative as it is generally plugged to Alternating Current (AC) socket through wires, eventually making it frustrating for the users.

To overcome this drawback, numerous recharging solutions are available. For example, regenerative braking systems, which is kind of braking system that can recapture vehicle's kinetic energy when brakes are applied and convert that kinetic energy into electricity which can be used to recharge vehicle's batteries. The regenerative braking systems uses reverse motor and generator functions during braking to generate a recharging current from kinetic energy that would otherwise be lost. However, this causes a lot of resistance in the vehicle and may create lot of brake related issues due to the generation of heat and normal wear and tear, thereby hindering the normal functioning of the braking system. Other recharging approach involves solar panels that provide an effective charge but is ineffective without solar energy.

Therefore, overcoming the above mentioned problems and increasing the travel range of electrically powered vehicles between downtimes for battery recharging can significantly increase the use of electrically-powered vehicles.

### BRIEF SUMMARY OF THE INVENTION

The embodiment primarily relates to, but is not limited to, air powered battery charging system. In the embodiment, battery of an electrically powered vehicle (hereinafter referred as vehicle) is charged by utilizing air turbines. The system includes an assembly positioned in a forward compartment of the vehicle. The assembly includes air intake vents and air intake ducts that direct air inside the charging system with a specific force. The charging system further includes one or more air turbines coupled with one or more gears and one or more alternators. The air intake vents and air intake ducts direct air to cause rotation of the air turbine causing the air turbine and the coupled gears and alternators to rotate and generate an electric current. This electric current is used to charge the battery of the vehicle using a regulator that regulates power between the alternators and battery. In an embodiment, two batteries, for example a first battery and a second battery, is maintained inside the vehicle for efficient working of the system. The vehicle, initially, uses a first battery to run the vehicle and simultaneously charges a second battery while the vehicle is on move. In an embodiment, the system automatically switches to the second battery for vehicle operations (like running the vehicle) when the first battery discharges. The same charging mechanism is then applied to the first battery while the vehicle is moving. In an embodiment, the opening size of the air intake vents are also automatically controlled (computer controlled) by a controller that controls the opening size (air spacing) of the air intake vents based on the speed of the vehicle, power need and generation.

### DESCRIPTION OF THE DRAWINGS

The advantages and features of the present invention will become better understood with reference to the detailed description taken in conjunction with the accompanying drawings, wherein like elements are identified with like symbols, and in which:

FIG. 1 shows a perspective view of an electrically powered vehicle with air intake vents, in accordance with an example embodiment of the present invention;

FIG. 2 shows a perspective view of an air powered battery charging system for electrically powered vehicle, in accordance with an example embodiment of the present invention;

FIGS. 3A and 3B show a perspective view of the air intake vents including a plurality of vanes, in accordance with an example embodiment of the present invention;

FIG. 4 shows a perspective view of the air turbine charging system, in accordance with an example embodiment of the present invention;

FIGS. 5A, 5B, 5C and 5D show different perspective views of the air turbine charging system, in accordance with another example embodiment of the present invention;

FIG. 6 shows a flowchart depicting calculation of sizes of various components of the air turbine charging system, in accordance with an example embodiment of the present invention; and

FIG. 7 shows a flowchart depicting operations to use, charge and switch batteries while the vehicle is on move, in accordance with an example embodiment of the present invention.

### DETAILED DESCRIPTION OF THE INVENTION

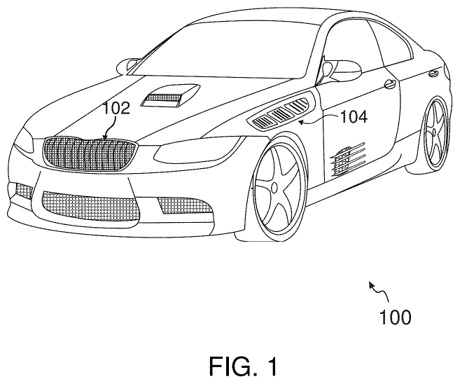

The best and other modes for carrying out the present invention are presented in terms of the embodiments, herein depicted in FIGS. 1 to 7. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect. The terms “a” and “an” herein do not denote a limitation of quantity, but rather denote the presence of at least one of the referenced item.

FIG. 1 shows a perspective view of an electrical powered vehicle 100 with air intake vents. The air intake vents are shown as 102, 104 and 106 (not shown in FIG. 1). Although FIG. 1 represents only three air intake vents, it should be obvious for the person skilled in the art to have more or less number of air intake vents. Further, these vents could be positioned/installed at different location on the body of the vehicle 100 in order to have appropriate air intake for proper functioning of the invention. In an embodiment, size of the air intake vents, for example the air intake vents 102-106 may also vary based on type, power and size of the vehicle 100.

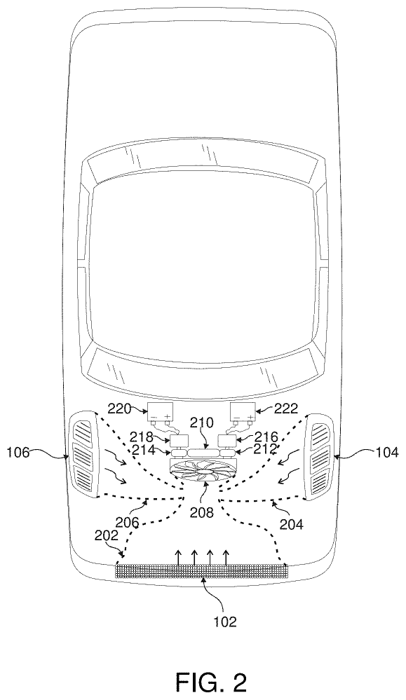

For the purpose of this description, the air intake vent 102 is positioned in a front grill section of the vehicle 100. In an embodiment, the air intake vent 102 is made as large as possible to maximize airflow into front compartment while driving the vehicle 100 forward. Two side air intake vents 104 and 106 (not shown in FIG. 1) are also located on either side of the vehicle 100 and are placed ahead of the front doors. The side air intake vents 104 and 106 would be useful in capturing the air from the sides depending on the wind flowing in respective directions. The air captured through the air intake vents (102-106) is then rushed to the air turbine charging system which in turn produces electric current and charges the battery of the vehicle 100. This is further explained in conjunction with FIG. 2.

Referring to FIG. 2, a perspective view of an air powered battery charging system for the vehicle 100 is shown. The vehicle 100 has air intake vents 102-106 (explained in conjunction with FIG. 1). Each of the air intake vents is associated with at least one air intake duct. As the vehicle 100 moves in a forward direction, air or wind enters a forward compartment through air intake vents 102-106 and is then guided through air intake ducts 202, 204 and 206. The air intake ducts 202, 204 and 206 are preferably funnel shaped from its respective air intake vents to a wind/air operated turbine 208 (also referred as air turbine 208). Thus the area of the air intake ducts 202, 204 and 206 is greatest near the air intake vents 102-106 and decreases as it moves towards the air turbine 208. In an embodiment, the air intake vents are made of plastic or polycarbonate. Although, the embodiment of the FIG. 2 shows one wind turbine, it may be obvious to the person skilled in the art to have multiple wind turbines depending on the size of the vehicle 100 and different criteria, like battery size and power generation.

As air flows through the air intake vents 102-106, it is compressed and accelerated by the air intake ducts 202-206 and is passed to the air turbine 208. The air turbine 208 has blades that rotate about their respective vertical axis. Air flowing to the air turbine 208 applies a force that causes the air turbine 208 to rotate. In an embodiment, the air entering the front compartment is discharged from the vehicle 100 using an air outlet duct (not shown in FIG. 2). In one embodiment, the air outlet duct is located in the rear of the vehicle 100 so that it creates lesser air pressure and drift.

The air turbine 208 is associated with one or more gears, for example a gear 210, a gear 212 and a gear 214. In an embodiment, the gears are mechanical parts that have cut teeth edges which mesh with another toothed part to transmit and vary torque. The gears 210-214 are in turn associated with alternators, for example an alternator 216 and an alternator 218. The alternators 216 and 218 are electrical generators that convert mechanical energy to electrical energy in the form of alternating current. The alternators 216 and 218 are further connected to one or more batteries of the vehicle 100, for example the battery 220 and 222.

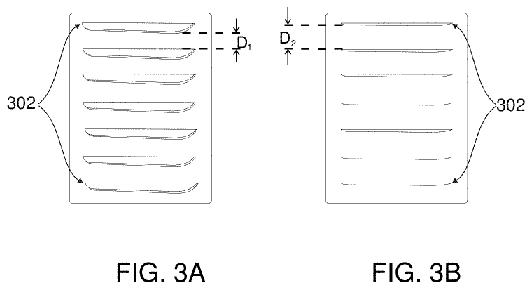

Thus, when the air turbine 208 rotates, it in turn rotates the alternators 216 and 218 with the help of the gears 210-214. The alternators 216 and 218, converts this mechanical energy generated by the rotation, to electrical energy. This electric energy is then used to charge the batteries 220 and 222 alternatively. To maintain a constant conversion of mechanical energy to electrical energy and provide consistent charging power, the velocity and quantity of the air intake may be increased or decreased by controlling air passage/spacing in the air intake vents 102-106. Controlling of the air passage/spacing in the air intake vents is explained in conjunction with FIG. 3A and FIG. 3B.

FIGS. 3A and 3B is a schematic view of an air intake vent (such as the air intake vent 102) including a plurality of vanes 302 in accordance with certain example embodiments. As the vehicle 100 moves forward the air intake takes place from the front of the vehicle 100. Thus the air will flow through the spacing between the plurality of vanes 302 associated with an air intake vent such as the air intake vent 102 (or the air intake vents 104 and 106). Thereafter, the air is passed through the air intake duct 202 to the wind operated turbine 208. In an embodiment, the plurality of vanes 302 associated with the air intake vent 102 may be retractable, directional, rotatable, movable or collapsible to decrease or increase the air intake while the vehicle 100 is moving.

To maintain a constant electric energy required for charging battery of the vehicle 100, the air spacing between the plurality of vanes 302 should be dynamically controlled based on the speed of the moving car and also on charge remaining in an operative battery. For example, if the vehicle 100 is travelling in a low speed the spacing between the vanes 302 (i.e. opening size of the air intake vent 102) will be increased so that more air passes inside the air intake duct 202 and the velocity of the air may be increased to a level sufficient to cause rotation of the air turbine 208.

In an embodiment, the plurality of vanes 302 may be formed using a smooth material, for example, a smooth rubberized material for providing a smooth surface. This may be advantageous for easily guiding the air inside the air intake duct 202. In an embodiment, each vent is collapsible, expandable and retractable so as to increase or decrease the air intake while the vehicle 100 is moving. In another embodiment, the plurality of vanes 302 is rotatable on its axis to increase or decrease the air intake by causing obstruction to the incoming air through angularly positioned vanes. For example, when the plurality of vanes 302 are parallel to air intake vents chamber, the air intake is maximum as the obstruction caused by the vent 102 is minimum and the spacing for air intake between each vanes is increased. This is shown in FIG. 3B. However, if the plurality of vanes 302 is positioned at a predefined angle, say 45 degree, then the spacing for air intake decreases as the vanes causes obstruction and the amount of air entering inside the air intake duct 202 decreases. This is shown in FIG. 3A. The air intake spacing between the plurality of vanes 302 is shown as ‘D1’ and ‘D2’ in FIG. 3A and FIG. 3B respectively, where ‘D2’ is greater than ‘D1’.

For clarity, altering the spacing between the plurality of vanes 302 is further explained with the following example. Considering, when the vehicle 100 is travelling at a very high speed, some or all of the vanes of the air intake vent, say air intake vent 102 may retract, since the air entering into the air intake duct 202 will already be at a sufficient velocity to produce the desired rotation of the air turbine 208. Similarly, when the vehicle 100 is travelling at a very low speed, some or all of the vanes may be parallel to the air intake vents, for example the air intake vent 102 or collapse towards their side such that the velocity of the air entering into the air intake duct 202 is increased. In an embodiment, a controller automatically controls the air spacing between the plurality of vanes 302 based on the prevailing and/or changing conditions.

In an embodiment, the controller controlling the plurality of vanes 302 is operably connected to the vehicles speedometer to automatically change the spacing between the air intake vanes 302 based on the current speed of the vehicle 100. In an example embodiment, although only seven vanes are shown in the FIGS. 3A and 3B, different example embodiments may use different numbers of vanes.

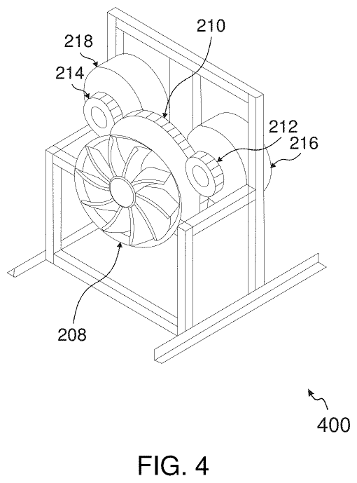

Referring to FIG. 4 shows a perspective view of the air turbine charging system in accordance with an example embodiment of the present invention. The air turbine charging system 400 encloses the air turbine 208. During forward motion of the vehicle 100, air enters from the air intake vents 102-106 and through air intake ducts 202-206 (not shown in FIG. 4) the air is then funneled at the air turbine 208. In an embodiment, the air is exhausted out from the backside of the air turbine charging system 400 through an exhaust vent.

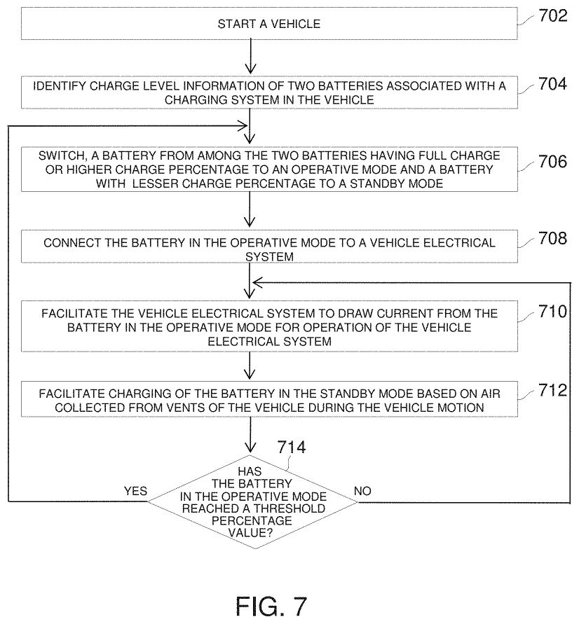

In an embodiment, the air turbine 208 is mounted on a shaft and turns a large gear i.e., the gear 210, also mounted on the shaft. The gear 210 is associated with two smaller gears 212 and 214, one on each side. Each small gear 212 and 214 drives an alternator, for example the alternator 216 and the alternator 218. The gear ratio from large gear 210 to small gears 212 and 214 is such to maximize the rotation speed of each alternator to yield maximum power output from the alternator 216 and the alternator 218 even for slow forward motion of the vehicle 100. The alternators 216 and 218 can then be connected to one or more batteries of the vehicle 100, for example the batteries 220 and 222. The alternators 216 and 218 coverts the mechanical energy generated by the rotation, to electrical energy. This electric energy is then used to charge the battery 220 or the battery 222, when any one of them is put on a standby mode. This is further explained in conjunction with FIG. 7.

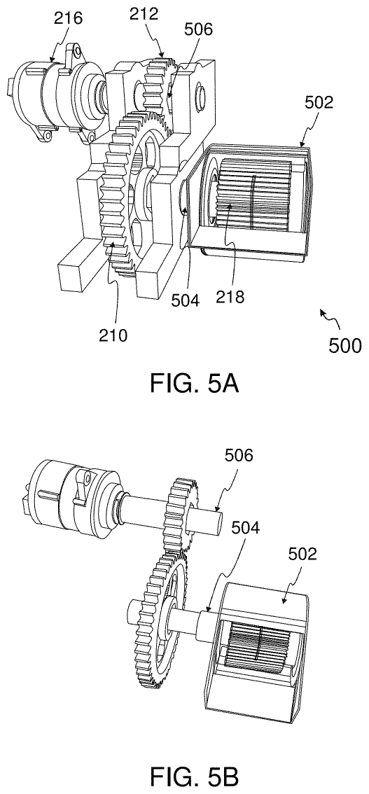

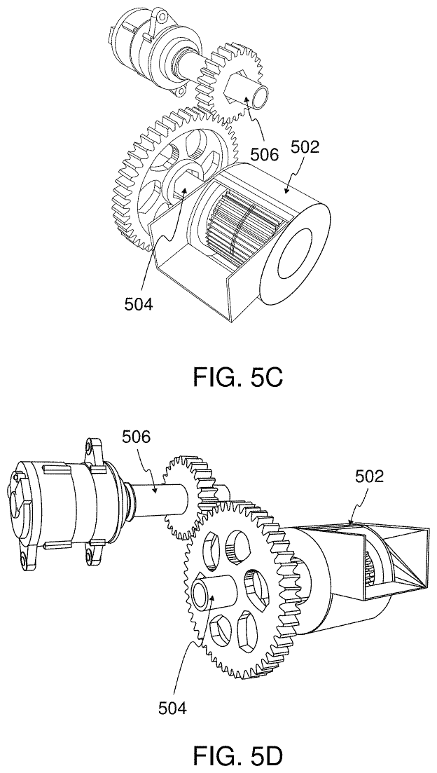

In an example embodiment, although only one turbine, three gears and two alternators are shown, it nowhere limits the invention to such numbers and different example embodiments may use more numbers of turbines or may use different types of air turbine and additionally more or less number of gears and alternators can also be used. In another example embodiment, the alternators 216 and 218 may be replaced by one or more generators (not shown in figures) for converting mechanical energy into electrical energy. For example, each of the small gear 212 and 214 may be configured to drive a generator and the generator may then be used for charging one or more batteries such as the batteries 220 and 222 of the vehicle 100. Alternatively, a combination of one or more alternators and one or more generators may also be used to be driven by respective gears for charging respective batteries. For the sake of clarity and for the purpose of this description, an air turbine charging system with different type of air turbine than the air turbine charging system 400 with less number of gears and alternators is shown and is described in conjunction with FIGS. 5A, 5B, 5C and 5D.

FIGS. 5A, 5B, 5C and 5D show different perspective views of an air turbine charging system 500 in accordance with another example embodiment of the present invention. Referring to FIG. 5A, shows an enlarged view the air turbine charging system 500. The air turbine charging system 500 has a frame 502 that encloses the air turbine 208. The frame 502 is cut open to show the air turbine 208. The air turbine 208 is mounted on a shaft 504 and turns a large gear, for example the gear 210, also mounted on the shaft 504. A small gear, for example the gear 212, is associated with the gear 210 and is mounted on a shaft 506 that also mounts an alternator, for example the alternator 216.

In accordance with the embodiment of the invention, during the forward motion of the vehicle 100, air enters from the air intake vents 102-106 (not shown in FIG. 5A) and through the air intake ducts 202-206 (not shown in FIG. 5A) the air is then funneled at the air turbine 208. In an embodiment, the air is exhausted out from the backside of the air turbine charging system 500 through an exhaust vent.

The air entering thorough the air intake ducts 202-206 enters the frame 502 to turn the air turbine 208 that is mounted on the shaft 504. On rotation of the air turbine 208, the gear 210 also mounted on the shaft 504 rotates. When the gear 210 rotates, it further rotates the gear 212 mounted on the shaft 506 which in turn rotates the alternator 216 mounted on the shaft 506.

The gear ratio from the gear 210 to the small gear 212 is designed to maximize the rotation speed of the alternator 216 to yield maximum power output. The alternators 216 can then be connected to one or more batteries of the vehicle 100, for example the alternator 216 is connected to the battery 220. The alternators 216 coverts the mechanical energy generated by the rotation, to electrical energy. This electric energy is then used to charge the battery 220 on a standby mode.

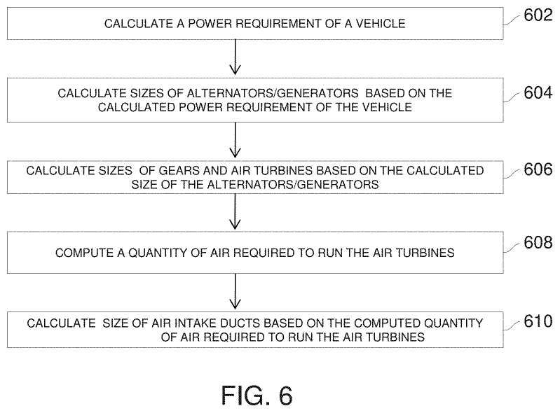

For the sake of clarity and for the purpose of this description, the air turbine charging system 500 is shown with respect to different views. FIG. 5B shows top view of the air turbine charging system 500. However, FIG. 5C and FIG. 5D show the side views of the air turbine charging system 500. It is noted that, sizes of various components of the air turbine charging system 500 such as the air intake ducts 202-206, the air turbine 208, the gears 210, 212 and 214 and the alternators 216 and 218 may be different for different power requirements of the vehicle 100. One such example method of calculation of the sizes of components related to the air turbine charging system 500 is explained in conjunction with FIG. 6.

FIG. 6 shows a flowchart depicting calculation of sizes of various components of the air turbine charging system (e.g., 400 or 500), in accordance with an example embodiment of the present invention. At 602, a power or an electricity requirement of a vehicle, such as the vehicle 100 is calculated. Further, based on the calculated power requirement of the vehicle 100, the sizes of various components of the air turbine charging system (the air turbine charging systems 400 and 500) may be computed. For example, at 604, sizes of alternators/generators (such as the alternators 216 and 218) required for the air turbine charging system is calculated based on the power requirements of the vehicle 100. Further, at 606, sizes of the gears (such as the gears 210, 212, and 214) and air turbines (such as the air turbine 208) are calculated based on the calculated sizes of the alternators/generators. Also, at 608, a quantity of air required to run the air turbines is computed. Thereafter, at 610, sizes of air intake ducts (such as the air intake ducts 202-206) is calculated based on the computed quantity of air required to run the air turbines.

Accordingly, if the power requirement of a particular vehicle is known, a required size of the alternator\generator can be calculated, which will again be used to calculate torque sizes of the gears needed to run the alternators\generators. Further, based on a formula, the quantity of air needed to collect from outside the vehicle to run into the air ducts and to be enough to run the air turbines, is computed. Thereafter, the configuration (e.g., sizes) of the air ducts can be selected to fulfill the required quantity of air to run the air turbines. It is noted that, power or electricity requirement may be identical and/or different for different type of vehicles, and the factors such as size of air intake ducts, gears, air turbines and alternators/generators may be distinct for each vehicle depending upon its power or electricity requirement. The operations related to use of vehicle battery and charging of the battery is further explained in conjunction with FIG. 7.

Referring now to FIG. 7, a flowchart depicting operations to use, charge and switch batteries while the vehicle 100 is moving is shown. At 702, the vehicle 100 is actuated using “start” function, probably by an electrical switch or key switch from within the vehicle 100. At 704, charge level information of two batteries is identified, for example the battery 220 and 222, associated with the air turbine charging system 400 or the air turbine charging system 500. In an embodiment, the charge percentage of the batteries 220 and 222 is identified.

At 706, battery having full charge or higher charge percentage is switched to operative mode and the battery with lesser charge percentage is switched to standby mode. For example, the battery 220 is switched to operative mode and the battery 222 to standby if the percentage charge in the battery 220 is higher than the battery 222. Otherwise, the battery 222 is made operative battery and the battery 220 is made as standby. For the purpose of this description and for the sake of clarity, the battery 220 is considered in operative mode and the battery 222 is considered to be in standby mode.

At 708, the battery in operative mode is connected to a vehicle electrical system. For example, if the battery 220 is switched to operative mode then the battery 220 is connected to the vehicle electrical system. At 710, facilitate the vehicle electrical system to draw current for operation from the battery in operative mode, for example the battery 220.

At 712, charging of the battery in the standby mode is facilitated based on air collected from the vents of the vehicle 100. More specifically, the vehicle motion activates air turbine, for example the air turbine 208, and using the gears 210, 212, and 214 and the alternators 216 and 218 and charges the battery in the standby mode. For example, the battery 220 gets depleted and the battery 222 is charged. At 714, the percentage charge of the battery in operative mode is compared with a threshold percentage value and if the percentage battery charge is greater than the threshold value then the vehicle electrical system continues to draw current for operation from the battery in operative mode i.e. from the battery 220 as explained at 706. However, if the charge percentage of the battery in the operative mode is equal to or less than the threshold value then the operative and standby batteries is switched. Therefore the standby battery which got recharged during movement of the vehicle 100 becomes the battery in operative mode and the battery that got depleted while driving the vehicle 100 will be put on standby mode for recharging. For example, the battery 220 is switched to operative mode and the battery 222 to standby mode.

Various embodiments of the present invention (explained in conjunction with FIGS. 1-7) provide a system for charging batteries of the electrically powered vehicles utilizing a wind operated turbine (air turbine). In an embodiment, the system charges the battery free of cost. The running time of the electrical powered vehicles is also increased as the batteries are charged and switched while the vehicle is on the move. The system is efficient as the vehicle does not have to be stationed for charging.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. Disclosed is an air turbine charging system for an electrically powered vehicle. air intake vents and air intake ducts that direct air inside the system while the vehicle is moving. The air turbine is coupled with gear and an alternator. The air intake vents and air intake ducts direct air to cause rotation of the turbine causing the coupled gear and alternator to rotate and cause an electric current.
